(19) United States
(12) Patent Application Publication
(10) Pub. No.: US 2025/0275494 A1
(43) Pub. Date: Sep. 4, 2025

(54) QUICK-COUPLING HOOK WITH FACILITATED OPERATION

(71) Applicant: JOST-Werke Deutschland GmbH, Neu-Isenburg (DE)

(72) Inventors: Hannu Paukamainen, Tikkakoski (FI); Lasse Mäkelä, Jyväskylä (FI)

(21) Appl. No.: 19/065,282

(22) Filed: Feb. 27, 2025

(30) Foreign Application Priority Data
Mar. 2, 2024 (DE) 10 2024 106 098.0

(51) Int. Cl. A01B 59/00

(52) U.S. Cl. CPC A01B 59/006

(57) ABSTRACT

A quick-coupling hook having a hook body, a securing lock, an actuating component coupled with the securing lock for common movement, a pre-tensioning spring, a first hook body-side abutment formation on a first side of the actuating component, and a second hook body-side abutment formation on a second side of the actuating component opposite to the first side, where the pre-tensioning spring extends between a hook body-side and an actuating component-side spring bearing and pre-tensions the actuating component towards its operating position, where the actuating component in its operating position abuts against the first and against the second hook body-side abutment formation, where it is provided that in a reference state of the quick-coupling hook, in which the actuating component is in an operating position and the securing lock in a decoupling-preventing securing position, a virtual straight connecting line passing through both the hook body-side spring bearing and the actuating component-side spring bearing of the pre-tensioning spring exhibits at least double the distance from the first hook body-side abutment formation as it does from the second hook body-side abutment formation.

This Application claims priority in German Patent Application DE 10 2024 106 098.0 filed on Mar. 2, 2024, which is incorporated by reference herein.

The present invention concerns a quick-coupling hook, in particular for agricultural vehicles. Such a quick-coupling hook, which is used for example as part of a liftable and lowerable tractor-side three-point coupling for coupling agricultural working tools, such as for instance ploughs, harrows, and the like, comprises:
i. A hook body with a hook mouth, where the hook mouth exhibits an accommodating region accessible through an opening region,
ii. A securing lock which is accommodated at the hook body and which is displaceable relative to the hook body between a securing position and a releasing position, where in the securing position the securing lock projects further into the opening region than in the releasing position,
iii. An actuating component which is accommodated at the hook body and which is moveable relative to the hook body between an operating position and a setting-up position, where the securing lock and the actuating component are coupled with one another for common movement in such a way that when the actuating component is in its setting-up position, the securing lock is in its releasing position, and that when the actuating component is in its operating position, the securing lock is in its securing position,
iv. A pre-tensioning spring which extends between a hook body-side spring bearing and an actuating component-side spring bearing and which pre-tensions the actuating component towards its operating position,
v. A first hook body-side abutment formation on a first side of the actuating component, and
vi. A second hook body-side abutment formation on a second side of the actuating component which is opposite to the first side.

The actuating component abuts in its operating position against the first and against the second hook body-side abutment formation. The actuating component exhibits a force application formation which is configured, through force application thereon, to move the actuating component starting from the operating position against the effect of the pre-tensioning spring in the direction of the setting-up position.

The quick-coupling hook is described in the present application, unless stated otherwise, in a reference state in which the actuating component is in its operating position free from external force application on the quick-coupling hook. Therefore at least in the reference state the aforementioned first and second hook body-side abutment formations are situated on the first side and on the second side opposite to the first of the actuating component.

The description of the quick-coupling hook in the reference state does not mean that the technical features specified in the description apply only to the reference state. They apply, however, at least in the reference state of the quick-coupling hook.

### BACKGROUND OF THE INVENTION

Such a quick-coupling hook of the type mentioned in the beginning is known from EP 1 849 632 A1. As is usual for quick-coupling hook, the known quick-coupling hook should allow it to establish in the shortest possible time a temporary positive-locking connection with a counter-coupling component, often a counter-coupling ball, to maintain it securely, and to disengage it again in the shortest possible time.

At the known quick-coupling hook, the actuating component can be secured in its setting-up position through an abutment engagement of a latching counter-formation of the actuating component with a hook body-side latching formation. In the setting-up position, a counter-coupling component previously coupled with the quick-coupling hook can be removed out of the accommodating region through the opening region of the hook mouth. Consequently, equipping or re-equipping of the vehicle carrying the quick-coupling hook can take place in the setting-up position of the actuating component.

In the operating position of the actuating component, a counter-coupling component accommodated in the accommodating region is secured through the securing lock, which is then in the securing position, against leaving the accommodating region and thereby against disengaging of the coupling connection. A vehicle carrying the quick-coupling hook can then operate with a coupled working tool.

A drawback in the known quick-coupling hook is the complicated movement sequence which an operator has to perform manually through finger engagement at the force application formation configured as an annular eyelet in order to move the actuating component securely from its operating position into its setting-up position and there secure it at the designated hook body-side latching formation.

To this end the operator has to pull out the actuating component accommodated in the operating position in the hook body translationally from the hook body and has to tilt the actuating component in the pulled-out state at the correct point in time against the pre-tensioning effect of the pre-tensioning spring. Untrained operators can require several attempts for this until they successfully bring the actuating component into the setting-up position, which thwarts the object of a quick-coupling hook.

### SUMMARY OF THE INVENTION

It is, therefore, the task of the present invention to facilitate the operating of the quick-coupling hook for moving the actuating component from the operating position into the setting-up position.

The present invention solves this task in the quick-coupling hook mentioned at the beginning thereby that in the mentioned reference state a virtual straight connecting line passing through both the hook body-side spring bearing and the actuating component-side spring bearing exhibits at least double the distance from the first hook body-side abutment formation as it does from the second hook body-side abutment formation.

The first and the second hook body-side abutment formation and the linking of the actuating component to the pre-tensioning spring at the actuating component-side spring bearing define position and orientation of the actuating component in its operating position. Starting from the operating position, the actuating component can be moved only translationally in the direction towards the setting-up position in a direction running between the first and the second hook body-side abutment formation.

In the quick-coupling hook discussed here, just as in the quick-coupling hook known from EP 1 849 632 A1, the actuating component is accommodated in a recess of the hook body, where in the reference state the actuating component is situated deeper in the recess than in its setting-up position.

The virtual straight connecting line which passes through the hook body-side spring bearing and through the actuating component-side spring bearing, indicates the line of action of the force with which the pre-tensioning force exerted by the pre-tensioning spring acts on the actuating component. As a result of the distance of the virtual straight connecting line from the first hook body-side abutment formation being at least double the distance of the virtual straight connecting line from the second hook body-side abutment formation, there is generated when removing the actuating component from its operating position through the pre-tensioning spring not only a pre-tensioning force, but a pre-tensioning force acting eccentrically on the actuating component. In addition to the pre-tensioning effect, this eccentric pre-tensioning force generates a torque acting on the actuating component, which as a tilt moment effects a tilt of the actuating component about a tilt axis running transversely, preferably orthogonally, to the trajectory of the translational movement of the actuating component. For the operator, therefore, it suffices to remove the actuating component from the operating position against the pre-tensioning effect of the pre-tensioning spring. A tilting movement which is desirable in particular for automatic fixing of the actuating component in its setting-up position, sets in by itself due to the arrangement of the two spring bearings of the pre-tensioning spring. Even an operator who thus far has not encountered the quick-coupling hook and therefore is unfamiliar with it, is therefore with the greatest probability already successful in the first attempt to move the actuating component from the operating position into the setting-up position and fix it there.

The tilting effect generated by the pre-tensioning spring at the actuating component is greater, the greater the distance of the virtual connecting axis from the first hook body-side abutment formation and the smaller the distance of the virtual connecting axis from the second hook body-side abutment formation. Therefore, the distance of the virtual connecting axis from the first hook body-side abutment formation is preferably at least five times greater than the distance of the virtual connecting axis from the second hook body-side abutment formation, especially preferably at least 10 times greater, and even more preferably at least 15 times greater.

To prevent unnecessarily high friction between the actuating component and the hook body-side abutment formations, which could hamper a movement of the actuating component out of its operating position, it is preferably provided that the virtual straight connecting line which is conceived to be running out via the two spring bearings, runs in the reference state of the quick-coupling hook between the first and the second hook body-side abutment formation. The virtual straight connecting line can be a tangent to the second hook body-side abutment formation, such that in this case the distance between the virtual straight connecting line and the second hook body-side abutment formation is zero. In this case, the distance of the virtual straight connecting line from the first hook body-side abutment formation is deemed to be greater by an infinitely large factor than the non-existing distance of the virtual straight connecting line from the second hook body-side abutment formation.

The virtual straight connecting line can also run beyond the second hook body-side abutment formation, such that both the first and the second hook body-side abutment formation lie on the same side of the virtual straight connecting line. In this case, the magnitude of the distance of the virtual straight connecting line from the second hook body-side abutment formation is used. A negative distance should not be used for analyzing the ratio of the two distances.

In order to fix the actuating component in its setting-up position, in the quick-coupling hook being discussed here too, it is preferably provided that the quick-coupling hook exhibits a hook body-side latching formation with which an actuating component-side latching counter-formation of the actuating component, in a setting-up state of the quick-coupling hook in which the actuating component is in the setting-up position, is engaged in order to hold the actuating component in the setting-up position against the effect of the pre-tensioning spring. Since a counter-coupling component accommodated in the hook mouth in the reference state of the quick-coupling hook is secured in the reference state against removal from the hook mouth and the quick-coupling hook is thus operationally ready, the reference state is also an operational state of the quick-coupling hook.

The actuating component is preferably a flat component which in two spatial directions orthogonal to one another exhibits considerably greater dimensions, approximately greater by at least a factor of three to four, than in its thickness direction. The contour of the actuating component can be complex, since the actuating component unifies in itself several functionalities and at the same time should exhibit the lowest weight possible. Thus preferably the actuating component-side latching counter-formation is configured as a contour section of the contour of the actuating component and therefore as part of its lateral surface. The force application formation of the actuating component can likewise impact the contour of the actuating component and at least section-wise be part of the contour.

As a flat component, the actuating component is preferably arranged in such a manner at and in the hook body that its thickness direction is oriented orthogonally to a cross-sectional area of the accommodating region surrounded by the hook mouth. Preferably, the actuating component executes between its operating position and its setting-up position a planar movement in the sense that the respective orientations of its thickness direction both in the operating position and in the setting-up position, preferably also in all intermediate positions, are parallel to one another.

In the reference state of the quick-coupling hook, the latching formation preferably lies on the same side of the actuating component as the first hook body-side abutment formation. The actuating component can then in the operational state abut against the first hook body-side abutment formation, and in the setting-up state can on the same side be engaged with its latching counter-formation with the hook body-side latching formation.

To avoid an unnecessarily large number of components for forming the quick-coupling hook, the hook body-side latching formation is preferably also the first hook body-side abutment formation. In a preferred development of the present invention, the hook body-side latching formation and thereby especially preferably also the first hook body-side abutment formation is a pin, for example a cylindrical or polyhedral pin, which especially preferably passed through a recess in the hook body in which the actuating component at least in its setting-up position is accommodated. The pin configured as a latching formation preferably runs parallel to the thickness direction of the actuating component at the hook body. Further preferably, the latching formation is a rotation-symmetrical component with respect to an axis of rotational symmetry parallel to the thickness direction of the actuating component, such as for instance a cylindrical pin, such that its orientation does not matter during its assembly.

Alternatively, the hook body-side latching formation and/or the first hook body-side abutment formation can be configured integrally with the hook body as a body formation of the latter.

The engagement of the actuating component-side latching counter-formation with the hook body-side latching formation is preferably a simple to establish abutment engagement, in which preferably an exterior surface section of a lateral surface of the actuating component as the actuating component-side latching counter-formation abuts against a lateral surface of the latching formation. For a stable abutment engagement, the latching counter-formation can be a section-wise negative reflection of the latching formation. For example, when the latching formation is formed by a cylindrical pin, the latching counter-formation can exhibit a negative part-cylindrical surface which in engagement with the latching formation surrounds the latter along a wrap angle of at least approximately 45°, preferably at least approximately 60°, especially preferably at least approximately 80°. In this case, the actuating component can be pivoted around the latching formation with the latching formation as a pivot axis, without having to disengage the abutment engagement of the latching counter-formation with the latching formation or actually undesirably disengaging it.

When, in the setting-up state of the quick-coupling hook, the actuating component-side latching counter-formation is in abutment engagement with the hook body-side latching formation, then in order to be able to hold the actuating component securely in its setting-up position despite merely an abutment engagement, the actuating component preferably exhibits a setting-up abutment counter-formation lying at a distance from the latching counter-formation which in the setting-up state abuts against a hook body-side setting-up abutment formation. In order to be able to secure the setting-up position of the actuating component which is defined solely through abutment engagements between formations of the actuating component on the one hand and of the hook body on the other, the virtual straight connecting line runs in the setting-up state at a distance from the latching formation in order to initiate a tilt moment in the actuating component which pushes the actuating component about the latching formation into an abutment engagement with the hook body-side setting-up abutment formation without undoing the abutment engagement with the latching formation.

In the setting-up state, the distance of the virtual straight connecting line from the hook body-side setting-up abutment formation preferably equals at most double the distance of the virtual straight connecting line from the hook body-side latching formation. Especially preferably, in the setting-up state the distance of the virtual straight connecting line from the hook body-side setting-up abutment formation does not exceed 1.25 times the distance of the virtual straight connecting line from the hook body-side latching formation.

In particular when, but not only when, the abutment engagement of the actuating component-side latching counter-formation with the hook body-side latching formation allows pivoting of the actuating component about the latching formation while maintaining the abutment engagement, then in the setting-up state the distance of the virtual straight connecting line from the hook body-side setting-up abutment formation is preferably smaller than the distance of the virtual straight connecting line from the hook body-side latching formation, since then the distance of the actuating component-side spring bearing from the actuating component-side latching counter-formation or the hook body-side latching formation, as the case may be, establishes a load arm on whose length, for a specified pre-tensioning force of the pre-tensioning spring, the tilt moment acting around the latching formation, initiated by the pre-tensioning spring in the actuating component, depends.

Thus the actuating component in its setting-up position can also be securely fixed at the hook body when the hook body-side setting-up abutment formation is configured as parallel to the virtual straight connecting line and thereby parallel to the direction of action of the pre-tensioning force of the pre-tensioning spring or only with a small tilt to it, such that it can only in a negligible manner support directly a pre-tensioning force of the pre-tensioning spring. In contrast, an abutment force resulting from the tilt moment initiated about the latching formation can always support the hook body-side setting-up abutment formation regardless of its orientation relative to the pre-tensioning force.

In a preferred concrete embodiment, in the reference state the first hook body-side abutment formation is situated on the side of the actuating component facing away from the hook mouth and the second hook body-side abutment formation is situated on the side of the actuating component facing towards the hook mouth.

The pre-tensioning force of the pre-tensioning spring preferably acts as parallel as possible to the direction of movement of the actuating component, such that as large a fraction as possible of the pre-tensioning force does actually act in the desired direction, namely towards the operating position. Further preferably, the actuating component is moved between its operating position and its setting-up position as parallel as possible to a mouth center plane oriented orthogonally to a cross-sectional area of the accommodating region surrounded by the hook mouth and running centrally both through the opening region and through the accommodating region. The mouth center plane preferably divides the cross-sectional area of the accommodating region surrounded by the hook mouth into two equally large area parts. Experts can readily visualize the mouth center plane of the hook mouth. Along an insertion trajectory lying in the mouth center plane there can moreover a counter-coupling component which is to be coupled with the quick-coupling hook be brought into the accommodating region of the hook mouth. For the aforementioned reasons, therefore, it is preferably provided that in the reference state and/or in the setting-up state, especially preferably also in an arbitrary intermediate position of the actuating component, the virtual straight connecting line encloses an angle not exceeding 15° with the mouth center plane and/or with a virtual insertion trajectory of a counter-coupling component to be coupled with the quick-coupling hook into the accommodating region.

Likewise, what is important for the ergonomics of an actuation of the actuating component is the arrangement of the quick-coupling hook being discussed here and its orientation in the mounted state on the vehicle carrying it. The hook body preferably exhibits an—ordinarily standardized—connection surface for connecting to a vehicle-side carrier. Especially preferably, this connection surface is a connection plane or a surface which is uncurved in at least in one direction. Ordinarily, the quick-coupling hook is welded by means of the connection surface onto a carrier of an agricultural vehicle. Since, however, here the quick-coupling hook is being discussed per se and without orientation relative to the vehicle carrying it, the connection surface offers the best possible indication for assessing the movement trajectory of the actuating component later in a state mounted on a vehicle. Preferably, the virtual straight connecting line encloses in the reference state and/or in the setting-up state, especially preferably also in an arbitrary intermediate position of the actuating component, with the connection surface an angle not greater than 10°. Further preferably, the connection surface encloses with the previously discussed mouth center plane and/or with the previously discussed insertion trajectory of a counter-coupling component into the accommodating region of the hook mouth an angle not greater than 10°.

In order to be able to move the actuating component as securely and disruption-free as possible at least from its operating position into its setting-up position, preferably however also in the opposite direction, according to a development of the present invention the actuating component exhibits a sliding surface which runs from an actuating component-side first abutment counter-formation with which in the reference state the actuating component abuts against the first hook body-side abutment formation up to the actuating component-side latching counter-formation. The actuating component can preferably slide with its sliding surface during its movement from the operating position into the setting-up position along an exterior surface of the latching formation, thus serving an operator manually moving the actuating component together with the latching formation as movement guidance, approximately in the manner of a cam or slotted guide.

In principle, the securing lock can be coupled arbitrarily kinematically with the actuating component. In a preferred embodiment of the quick-coupling hook being discussed here, the securing lock is simply and securely articulated pivotably about a virtual linkage axis at the actuating component. The linkage axis preferably runs in the thickness direction of the actuating component, thus preferably also in the direction in which the latching formation penetrates through the accommodating space of the hook body in which the actuating component is accommodated at least in its operating position.

For a stable position and orientation of the actuating component in its setting-up position, in the setting-up state of the quick-coupling hook the virtual linkage axis preferably lies on the same side as the latching formation with respect to a reference plane containing the virtual straight connecting line and oriented orthogonally to a cross-sectional area of the accommodating region surrounded by the hook mouth. The securing lock can be moveable only with difficulty relative to the hook body just immediately before reaching the setting-up position, due to abutment engagements of the securing lock with the hook body and thereby effected friction. The virtual linkage axis, so to speak spatially fixed through the securing lock, can then be a tilt axis for the actuating component on reaching the abutment engagement of the actuating component-side latching counter-formation with the hook body-side latching formation. The position of latching counter-formation and linkage axis in the setting-up state on the same side of the virtual connecting axis is then advantageous for the movement sequence to reach the mentioned abutment engagement of latching formation and latching counter-formation.

In principle, the force application formation is preferably provided for a manual actuation and/or movement respectively of the actuating component. To this end, the force application formation can comprise a rear grip formation for a manual finger grip or hand grip. Such a rear grip formation can be a handle or an annular eyelet or a reach-through aperture in the actuating component. In case of an annular eyelet or a reach-through aperture, it can preferably be gripped through in the thickness direction of the actuating component. Alternatively, a rod or a hand grip can serve as manual force engagement which projects out from the actuating component and can be gripped around by an operator.

Additionally or alternatively, the force application formation can comprise and/or be, as the case may be, a coupling formation of the actuating component for coupling with an output element of an actuator. When the actuating component should be moved through an actuator at least from the operating position into the setting-up position, the force application formation can be an arbitrary coupling formation for coupling the output element of the actuator with the actuating component, such as part of a ball joint, such as for instance a ball socket, or the like.

An advantageous tilting effect in the interaction of the pre-tensioning spring with an actuating force exerted on the actuating component in the direction away from its operating position can thereby be achieved that in the reference state a large part of the actuating component lies on the same side of the virtual straight connecting line on which the latching formation and/or the first hook body-side abutment formation also lies. Since the actuating component is a three-dimensional physical object, whereas the virtual straight connecting line is a linear shape, the arrangement of a large part of the actuating component on one side of the virtual straight connecting line is more simply expressed through a reference plane containing the virtual straight connecting line, which in contrast to the straight connecting line is capable of virtually intersecting the entire actuating component. Therefore it is preferably provided that in the reference state at least 75% of the actuating component lie on the same side with respect to a reference plane containing the virtual straight connecting line and oriented orthogonally to a cross-sectional area of the accommodating region surrounded by the hook mouth as the latching formation and/or the first hook body-side abutment formation. In particular, at least 75%, preferably at least 85% of the force application formation of the actuating component lie on this side of the reference plane, in order to effect under a force application to the force application formation a desirable tilt moment at the actuating component.

As already indicated above, the quick-coupling hook can exhibit an actuator in order to move the actuating component from the operating position into the setting-up position. The actuator can be an electromechanical, electromagnetic, pneumatic, or hydraulic actuator.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1A schematic side view of an embodiment according to the invention of the quick-coupling hook of the present application in the reference state without lateral covering, in order to show the components of the quick-coupling hook accommodated in the hook body,

FIG. 2A schematic side view as in FIG. 1, but with actuating component moved away from the operating position,

FIG. 3A schematic side view as in FIGS. 1 and 2 with actuating component moved out even further, where the actuating component is just before reaching its setting-up position, and

FIG. 4A schematic side view as in FIGS. 1 to 3 with the actuating component in the setting-up position and the quick-coupling hook in the setting-up state, respectively.

### DESCRIPTION OF PREFERRED EMBODIMENTS

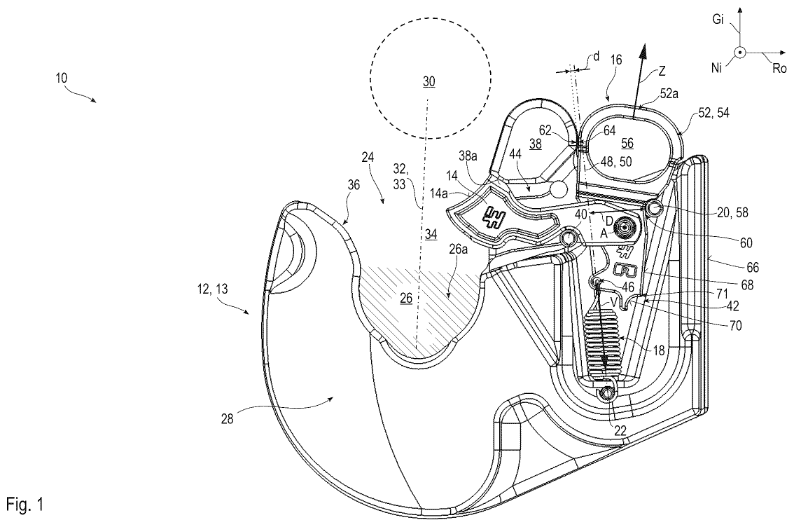

Referring now to the drawings wherein the showings are for the purpose of illustrating preferred and alternative embodiments of the invention only and not for the purpose of limiting the same, in FIG. 1, an embodiment according to the invention of a quick-coupling hook is labelled generally by 10. The quick-coupling hook 10 of FIG. 1 is not depicted completely, since a covering as part of the hook body 12 facing towards the observer of FIG. 1 is left out in order to be able to depict the components accommodated in the interior of the hook body 12: securing lock 14, actuating component 16, pre-tensioning spring 18, latching formation 20, and hook body-side spring bearing 22. Of the hook body 12, therefore, there is depicted in FIGS. 1 to 4 only a part-body 13, which however forms the largest part of the hook body 12.

For better orientation, a Cartesian triad in the top right-hand corner of FIGS. 1 to 4 indicates the vehicle axes of a vehicle not depicted in the drawings which carries the quick-coupling hook 10. The vehicle axes are the roll axis Ro, the pitch axis Ni, and the yaw axis Gi. The arrow of the roll axis Ro points in the forward travel direction of the vehicle. The quick-coupling hook 10 thus projects in the depicted embodiment example from the rear or from a carrier at the rear, as the case may be, of an agricultural vehicle in the reverse travel direction.

The hook body 12 or more precisely its part-body 13 depicted in FIGS. 1 to 4 exhibits as a central coupling formation a hook mouth 24, whose accommodating region 26 is surrounded on three sides by a hook section 28 curved in the shape of a hook. The accommodating region 26 is accessible through an opening region 34 to a counter-coupling component 30 depicted in FIG. 1 only in rough schematic form, such as a spherical section of a counter-coupling formation, along an insertion trajectory 32 determined by the shape of the through hook mouth. The insertion trajectory 32 lies in FIGS. 1 to 4 in a mouth center plane 33 orthogonal to the respective drawing plane of FIGS. 1 to 4 which is oriented orthogonally to a cross-sectional area 26a of the accommodating region 26 surrounded by the hook mouth 24 and running centrally both through the opening region 34 and through the accommodating region 26. The cross-sectional area 26a of the accommodating region 26 surrounded on three sides by the hook mouth 24 or more precisely by the hook section 28 is depicted hatched in FIG. 1.

A lead-in chamfer 36 at the hook section 28 in the opening region 34 facilitates the insertion of the counter-coupling component 30 into the accommodating region 26.

In FIG. 1, the securing lock 14 is in its securing position in which it protrudes maximally into the opening region 34 and prevents the escape of a counter-coupling component 30 accommodated in the accommodating region 26 along the insertion trajectory 32 but in the opposite direction, more precisely along the mouth center plane 33 through the opening region 34. Through the protrusion of the securing lock 14 into the opening region 34, the clear width of the opening region 34 is decreased to the extent that the counter-coupling component 30 does not pass through the remaining gap between the lead-in chamfer 36 and the securing lock 14. An abutment of the securing lock 14 in its securing position against a securing surface 38a of a hook body section 38 situated over the securing lock 14 in its securing position prevents a counter-coupling component 30 accommodated in the accommodating region 26 displacing the securing lock 14 from its securing position.

In the opposite direction, however, a counter-coupling component 30 is capable of reaching the accommodating region 26 despite a securing lock 14 arranged in its securing position, since the counter-coupling component 30 during opposite movement from outside into the accommodating region 26 can push the securing lock 14 out of its securing position.

The securing lock 14 is articulated pivotably at the actuating component 16 about a linkage axis A orthogonal to the drawing plane of FIG. 1.

Solely for the sake of completeness let it be mentioned that a counter-coupling component 30 moved from outside, i.e. in the case of FIG. 1 from above, along the mouth center plane 33 or along the insertion trajectory 32 respectively into the accommodating region 26 hits a concave contact surface 14a of the securing lock 14. The securing lock 14, which in its securing position abuts against a cylindrical tip formation 40 in the hook body 12, can tip about the tip formation 40, i.e. about a tip axis parallel to the linkage axis A, under the load application by the counter-coupling component 30 which is moved into the hook mouth 24. Hereby the longitudinal end of the securing lock 14 protruding into the opening region 34 is pressed downwards and the longitudinal end articulated at the actuating component 16 correspondingly displaced upwards. With the thus effected ejection movement of the actuating component 16 out of the recess 42 in the hook body 12 which accommodates it in the operating position shown in FIG. 1, the securing lock 14 can be pushed by the counter-coupling component 30 into the channel 44 which in FIG. 1 is bounded upwards by the hook body section 38 and downwards by the hook section 28, whereby the opening region 34 becomes passable for the counter-coupling component 30.

The pre-tensioning spring 18, which in a manner usual per se is a tension spring, is suspended at its hook body-remote end at an actuating component-side spring bearing 46, for instance a fastening eyelet which passes through the actuating component 16 in the thickness direction, that is, in the depicted embodiment example orthogonally to the drawing plane of FIG. 1. Through the choice of the location of the hook body-side spring bearing 22 at the hook body 12 on the one hand and of the location of the actuating component-side spring bearing 46 at the actuating component 16 on the other, the pre-tensioning force exerted by the pre-tensioning spring 18 on the actuating component 16 can be determined constructionally in its direction of action. Through the choice of the pre-tensioning spring 18, the pre-tensioning force is determined magnitude-wise as a function of its excursion.

A virtual straight connecting line 48 which connects the two spring bearings 22 and 46 with one another and of which only a section is shown in FIG. 1, indicates the direction of action of the pre-tensioning force V applied by the pre-tensioning spring 18 to the actuating component. The arrow of the pre-tensioning force V is meant to indicate the pre-tensioning force in FIG. 1 merely qualitatively. The virtual straight connecting line 48 runs in the depicted embodiment example in parallel to the drawing plane of FIG. 1 or at least in a plane 50 orthogonal to the drawing plane of FIG. 1. The cross-sectional area 26a of the accommodating region 26 is likewise oriented in parallel to the drawing plane of FIG. 1. The aforementioned plane 50 is, therefore, likewise orthogonal to it.

The pre-tensioning spring 18 urges the actuating component 16 in its operating position shown in FIG. 1. The pre-tensioning spring 18 thereby also pre-tensions the securing lock 14 in its securing position shown in FIG. 1. FIG. 1 therefore shows the quick-coupling hook 10 in the reference state mentioned in the descriptive introduction.

In the present case, however, it is less the displacement of the actuating component 16 through the securing lock 14 that is of interest but rather conversely the displacement of the securing lock 14 through a manual actuation of the actuating component 16.

At its upper longitudinal end projecting out of the recess 42, the actuating component 16 exhibits an annular eyelet 52 as a force application formation 54. The reach-through area 56 surrounded by the annular eyelet 52 is likewise oriented in parallel to the drawing plane of FIG. 1. The annular eyelet 52 is suitable and intended to be gripped from behind by one or two fingers of an operator, in order to then exert with the reaching-through fingers a merely qualitatively indicated tensile force Z on the actuating component 16 and to remove the actuating component 16 out of its operating position depicted in FIG. 1.

The actuating component 16 abuts on its from the hook mouth 24 remotely lying side against the latching formation 20, which is also a first hook body-side abutment formation 58 in terms of the descriptive introduction. A concavely curved, preferably negative part-cylindrical, first abutment counter-formation 60 nestles in the abutment situation against the convexly curved, preferably part-cylindrical or cylindrical, abutment surface of the first hook body-side abutment formation 58 or of the latching formation 20, respectively.

On the side of the actuating component 16 facing towards the hook mouth 24, the former abuts with a second abutment counter-formation 62 configured in the region of its annular eyelet against a second hook body-side abutment formation 64 configured at the hook body section 38. Through these abutment engagements and through the pre-tensioning force of the pre-tensioning spring 18, the actuating component 16 is adequately defined in its operating position and does not move without an external influence.

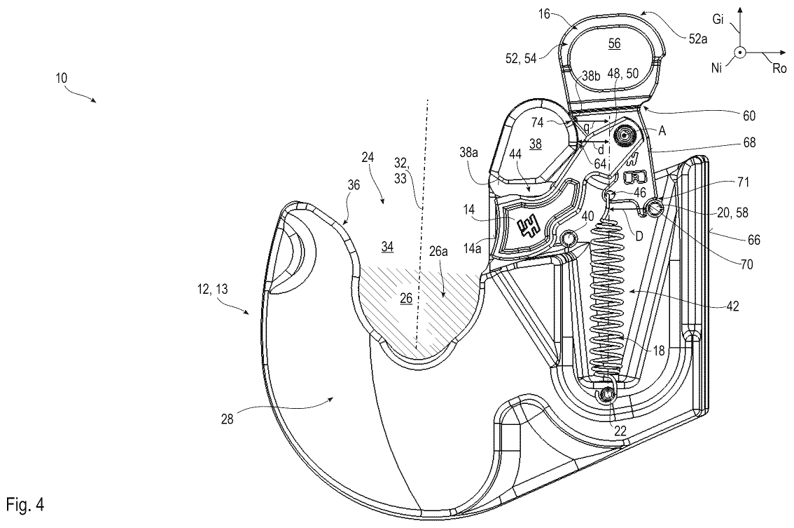

In order now to move the quick-coupling hook 10 starting from the operational state shown in FIG. 1 into the setting-up state shown in FIG. 4, in which the securing lock 14 is in the releasing position and the actuating component 16 is in the setting-up position, an operator after gripping through the annular eyelet 52 pulls at the latter in the direction of the arrow of the tensile force Z and begins to pull the actuating component out of the recess 42 of the hook body 12. If the annular eyelet 52, as in the present case, is larger than the diameter of a finger gripping through it, it makes sense to assume that the operator will grip at the section 52a of the annular eyelet 52 which essentially runs orthogonally to the desired pulling direction, that is, in the present case orthogonally to the arrow of the tensile force Z.

The locations of the two spring bearings 22 and 46 of the pre-tensioning spring 18 are so chosen that the virtual straight connecting line 48 which determines the course of the force effect for one thing runs as close as possible past the second hook body-side abutment formation 64 and for another does not deviate too much from the desired direction of the tensile force Z.

The respective direction of the tensile force Z depends on the respectively gripping operator and cannot be readily visualized from the device. On ergonomic ground, an advantageous direction of the tensile force Z in the reference state does not differ essentially from the orientation direction of the mouth center plane 33 or of the insertion trajectory 32, respectively, such that at least in the side view of FIG. 1 the virtual straight connecting line 48 encloses an angle with the mouth center plane 33 or the insertion trajectory 32, respectively, which preferably is not greater than 15°.

On the side of the hook body 12 facing away from the hook mouth 24, the former exhibits a connection surface 66 which ordinarily at least in the height direction of the quick-coupling hook 10 is not curved. The connection surface 66 is preferably a connection plane 66. With this connection surface 66, the quick-coupling hook 10 for attachment to a vehicle-side carrier is bonded with the latter, for instance butt welded onto the longitudinal end of the latter.

For the aforementioned reasons, in the reference state the virtual straight connecting line 48 preferably encloses with the connection surface 66 an angle not exceeding 10°.

Everything said here regarding the virtual straight connecting line 48 also applies to the plane 50 defined above as a reference plane 50 which contains the virtual straight connecting line 48.

As becomes clear from the depiction of FIG. 1, in the reference state the distance D of the virtual straight connecting line 48 from the first hook body-side abutment formation 58 is significantly greater than the distance d of the virtual straight connecting line 48 from the second hook body-side abutment formation 64. In the depicted embodiment example, the distance D is more than twelve times greater than the distance d. Through this arrangement, a large part of the volume and/or of the mass respectively of the actuating component 16, in the depicted embodiment example approximately 90% of the volume and of the mass of the actuating component 16, is situated on a side of the virtual straight connecting line 48 and/or of the plane 50 respectively on which the tensile force Z also engages through the operator. This is also the side on which the latching formation 20, which in the setting-up state of FIG. 4 secures the actuating component 16 in its setting-up position, is situated.

The virtual straight connecting line 48 and/or the plane 50 respectively runs outside the reach-through area 56 of the annular eyelet 52, which further increases the tilt moment about a tilt axis orthogonal to the drawing plane of FIG. 1 effected through the tensile force Z and the pre-tensioning force V.

Through this design, the tensile force Z and the pre-tensioning force V effect a tilt moment exerted on the actuating component 16, which pushes the actuating component 16 to tilt anticlockwise in FIG. 1.

This tilt moment ensures that even in the case of an operator pulling thoughtlessly and without a defined pulling direction at the annular eyelet 52 with the tensile force Z, after leaving the operating position a sliding surface 68 at the outer circumference of the actuating component 16 abuts against the latching formation 20 and/or against the first hook body-side abutment formation 58 respectively. The movement of the actuating component 16 when being pulled out of the recess 42 is guided by sliding of the sliding surface 68 along the first hook body-side abutment formation 58 and/or latching formation 20, respectively.

The sliding surface 68 which in the depicted embodiment example extends over the thickness of the actuating component 16 runs from the first abutment counter-formation 60 up to an actuating component-side latching counter-formation 70, which in the setting-up position of the actuating component 16 is in abutment engagement with the latching formation 20. The actuating component-side latching counter-formation 70 is designed as a negative part-cylindrical shape, such that it can abut flat in a nestling manner against the cylindrical latching formation.

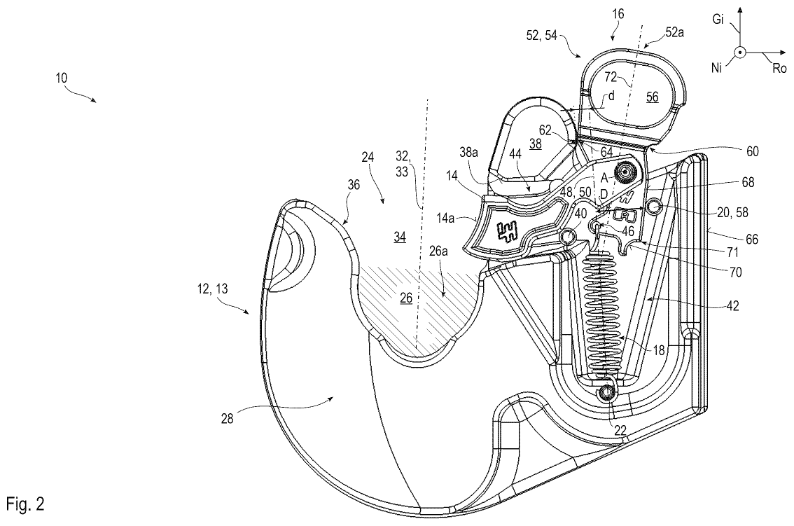

FIG. 2 shows the quick-coupling hook 10 of FIG. 1 in a transitional phase, after the actuating component 16 has been pulled manually out of the recess 42 to a certain extent out of its operating position shown in FIG. 1.

Due to the pullout of the actuating component 16 out of the recess 42, the pre-tensioning spring 18 is more strongly tensioned than in FIG. 1, whereby the pre-tensioning force exerted by the pre-tensioning spring 18 on the actuating component 16 has increased in magnitude. In terms of an equilibrium of forces, therefore, the tensile force to be applied by the operator has also become greater. In FIG. 2, neither tensile force nor pre-tensioning force are recorded but their lines of action are depicted, once in the known form of the virtual straight connecting line 48 and once more through the line of action 72 which in the depicted embodiment example is likewise parallel to the drawing plane of FIG. 1.

Due to the tilt moment effected by the tensile force and pre-tensioning force, the actuating component 16 abuts with its sliding surface 68 against the latching formation 20. On the edge side facing towards the hook mouth 24, the actuating component 16 still abuts against the second hook body-side abutment formation 64. The second actuating component-side abutment counter-formation 62 therefore constitutes in the present embodiment example, like the sliding surface 68, an edge surface usable as a sliding surface running in the thickness direction of the actuating component 16.

The hook body-side spring bearing 22 is by its very nature fixed in place with respect to the hook body 12. A change in position of the two spring bearings 22 and 46 therefore originates solely from the actuating component-side spring bearing 46. As is discernible in the position of the virtual straight connecting line 48 in FIG. 2, the virtual straight connecting line 48, through the pullout of the actuating component 16 from its operating position into the position shown in FIG. 2, has moved a little away from the second hook body-side abutment formation 64 and moved a little nearer to the latching formation 20. Nevertheless, the virtual straight connecting line 48 still as before lies nearer to the second hook body-side abutment formation 64. More than 50% of the volume and/or of the mass respectively, in the present case approximately 80% of the volume and of the mass, of the actuating component 16 still lies on the same side of the virtual straight connecting line 48 on which the latching formation 20 also lies, i.e. on the side of the virtual straight connecting line 48 facing away from the hook mouth 24. The distance D of the virtual straight connecting line 48 from the latching formation 20 equals now approximately three times the distance d of the virtual straight connecting line 48 from the second hook body-side abutment formation 64.

At least 75%, here even 100%, of the reach-through region 56 of the annular eyelet 52 too, still lies on the same side of the virtual straight connecting line 48 as the latching formation 20.

Through the pulling out of the actuating component 16, the securing lock 14 is withdrawn further into the channel 44 and releases a section of the opening region 34 which in FIG. 1 is still occupied.

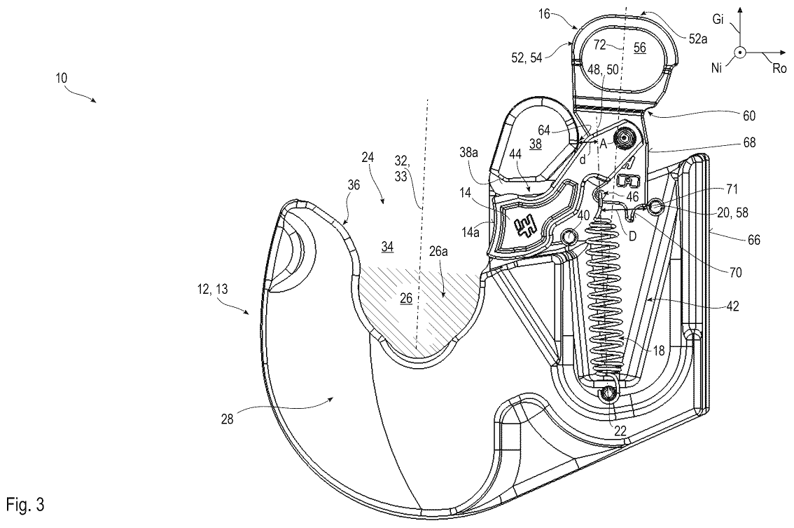

In order to move the actuating component 16 into the setting-up position, it has to be pulled even further out of the recess 42 against the pre-tensioning effect of the pre-tensioning spring 18. FIG. 3 shows a more pulled-out state.

FIG. 3 shows a pullout state of the actuating component 16 out of the recess 42 shortly before the actuating component-side latching counter-formation 70 comes into abutment against the hook body-side latching formation 20. The actuating component 16 is pulled out of the recess 42 so far that now a boundary edge 71 separating the sliding surface 68 from the actuating component-side latching counter-formation 70 is in abutment against the latching formation 20.

Through the even stronger pullout of the actuating component 16 out of the recess 42, the virtual straight connecting line 48 has moved a little further away from the second hook body-side abutment formation 64 towards the latching formation 20, where however it still lies significantly nearer to the second hook body-side abutment formation 64. The distance D of the virtual straight connecting line 48 from the latching formation equals in the state shown in FIG. 3 a little more than twice the distance d of the virtual straight connecting line 48 from the second hook body-side abutment formation 64.

As before, the pre-tensioning force exerted by the pre-tensioning spring 18 on the actuating component 16 and the tensile force exerted by finger grip at the section 52a of the annular eyelet 52 on the actuating component 16, ensure a tilt moment acting on the actuating component 16 anticlockwise when observing FIG. 3, which presses the boundary edge 71 between the sliding surface 68 and the latching counter-formation 70 against the latching formation 20. On the side of the actuating component 16 facing towards the hook mouth 24, no abutment engagement with the hook body 12 takes place any longer.

At least 75%, here even at least 80% of the reach-through region 56 of the annular eyelet 52 are still situated on the same side of the virtual straight connecting line 48 as the latching formation 20.

A slight further pulling out of the actuating component 16 leads, due to the movement of the boundary edge 71 relative to the latching formation 20 and due to the described tilt moment, to a tilting movement of the actuating component 16 anticlockwise, which is ended only through the abutment of the latching counter-formation 70 against the latching formation 20. Since the actuating component 16 is connected pivotably with the securing lock 14 about the linkage axis A and since further the securing lock 14 abuts against a surface of the hook body 12 at two places arranged at a distance from one another, the linkage axis A can guide a tilting movement of the actuating component 16 anticlockwise induced by the described tilt moment. This tilting movement would, however, take place in the described manner even if the securing lock 14 were not present. Therefore, regardless of how the operator pulls the actuating component 16 further out of the recess 42, starting from FIG. 3, the actuating component 16 will come to abutment with its latching counter-formation 70 against the latching formation 20.

The boundary edge 71 does not have to be a sharp edge, but rather can be a boundary region separating the sliding surface 68 from the latching counter-formation 70.

The securing lock 14 is almost completely withdrawn into the channel 44.

Finally, in FIG. 4 there is depicted the setting-up state of the quick-coupling hook 10 in which the actuating component 16 is in its setting-up position. The latching counter-formation 70 abuts in a nestling manner against the latching formation 20, and through the pre-tensioning force of the pre-tensioning spring 18 the actuating component 16 is pushed about the latching formation 20 to abutment against the hook body section 38 on its side facing towards the hook mouth 24. More precisely, a setting-up abutment counter-formation 74 of the actuating component 16 configured on the side of the actuating component 16 facing towards the hook mouth 24 at a distance from the latching counter-formation 70 abuts against a hook body-side setting-up abutment formation 38b formed by an area section of the hook body section 38. The actuating component 16 is again, through the abutment engagements between the latching counter-formation 70 and the latching formation 20 on the one hand and between the setting-up abutment counter-formation 74 and the setting-up abutment formation 38b on the other and under the effect of the pre-tensioning spring 18, in a stable position which can only be changed through an external force application.

The securing lock 14 is now completely withdrawn into the channel 44 and the opening region 34 is available in its entire clear width for an insertion or a removal of a counter-coupling component into the accommodating region 26 or out of the accommodating region 26, respectively.

The virtual straight connecting line 48 has, compared with FIG. 3, moved even further away from the second hook body-side abutment formation 64 and moved nearer to the latching formation 20. The virtual straight connecting line 48 preferably never moves, during the entire movement process of a movement of the actuating component 16 out of its operating position into the setting-up position shown in FIG. 4, nearer to the latching formation 20 than would make the distance d twice greater than the distance D.

The distance D of the virtual straight connecting line 48 from the latching formation 20 is furthermore approximately as great as or slightly greater than a distance q of the virtual straight connecting line 48 from the hook body-side setting-up abutment formation 38b. The distance q, with the given construction of the embodiment example, is slightly greater than the distance d of the virtual straight connecting line 48 from the second hook body-side abutment formation 64. The distance q preferably also becomes no greater than double, preferably than 1.25 times, the distance D. Thereby there is maintained, through the pre-tensioning spring 18, an adequate tilt moment about the latching formation 20 acting on the actuating component 16.

In all the states of the quick-coupling hook 10 shown in FIGS. 1 to 4, the virtual linkage axis A is situated on the same side of the virtual straight connecting line 48 as the hook body-side latching formation 20.

Out of the securing position shown in FIG. 1 the actuating component 16 does not get into the setting-up position shown in FIG. 4 through pushing of the securing lock 14 by means of a counter-coupling component 30 which is moved into the hook mouth 24, but only through manual or actuator actuation of the actuating component 16. If, in contrast, the securing lock 14 is pushed out of its securing position by means of a counter-coupling component 30 being moved into the hook mouth 24, this pushing out is only temporary. As soon as the counter-coupling component 30 entering the hook mouth 24 has passed the pushed out securing lock 14, the latter is moved by the pre-tensioning spring 18 back into its securing position.

By means of a movement of the force application formation 54 in FIG. 4 in the direction away from the hook mouth 24 or more precisely from the mouth center plane 33 and towards the connection surface 66, the quick-coupling hook 10 can be moved back into the operational or reference state, as the case may be, of FIG. 1. Due to the physical movement restriction of the securing lock 14 by the hook body 12 shown in FIG. 4, under the mentioned force load of the actuating component 16 the linkage axis A remains essentially in the position shown in FIG. 4. The actuating component 16 pivots clockwise—when observing FIG. 4—about the linkage axis A, whereby the latching counter-formation 70 is no longer in engagement with the latching formation 20. The pre-tensioning spring 18 then forces the actuating component into its operating position and consequently the securing lock 14 into its securing position.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. A quick-coupling hook for agricultural vehicles, comprising
i. a hook body with a hook mouth, where the hook mouth exhibits an accommodating region accessible through an opening region,
ii. a securing lock which is accommodated at the hook body and which is displaceable relative to the hook body between a securing position and a releasing position, where in the securing position the securing lock projects further into the opening region than in the releasing position,
iii. an actuating component which is accommodated at the hook body and which is moveable relative to the hook body between an operating position and a setting-up position, where the securing lock and the actuating component are coupled with one another for common movement in such a way that when the actuating component is in its setting-up position, the securing lock is in its releasing position, and that when the actuating component is in its operating position, the securing lock is in its securing position,
iv. a pre-tensioning spring which extends between a hook body-side spring bearing and an actuating component-side spring bearing and which pre-tensions the actuating component towards its operating position,
v. a first hook body-side abutment formation on a first side of the actuating component, and
vi. a second hook body-side abutment formation on a second side of the actuating component which is opposite to the first side,
where the actuating component abuts in its operating position against the first and against the second hook body-side abutment formation,
where the actuating component exhibits a force application formation which is configured, through force application thereon, to move the actuating component starting from the operating position against the effect of the pre-tensioning spring in the direction of the setting-up position,
where in a reference state of the quick-coupling hook in which the actuating component is in its operating position, a virtual straight connecting line passing through both the hook body-side spring bearing and the actuating component-side spring bearing exhibits at least double the distance from the first hook body-side abutment formation as it does from the second hook body-side abutment formation.

17. The quick-coupling hook according to claim 16, wherein in the reference state of the quick-coupling hook the virtual straight connecting line runs between the first and the second hook body-side abutment formation.

18. The quick-coupling hook according to claim 17, wherein the quick-coupling hook exhibits a hook body-side latching formation with which an actuating component-side latching counter-formation of the actuating component, in a setting-up state of the quick-coupling hook in which the actuating component is in the setting-up position, is engaged in order to hold the actuating component against the effect of the pre-tensioning spring in the setting-up position.

19. The quick-coupling hook according to claim 16, wherein the quick-coupling hook exhibits a hook body-side latching formation with which an actuating component-side latching counter-formation of the actuating component, in a setting-up state of the quick-coupling hook in which the actuating component is in the setting-up position, is engaged in order to hold the actuating component against the effect of the pre-tensioning spring in the setting-up position.

20. The quick-coupling hook according to claim 19, wherein in the reference state of the quick-coupling hook the hook body-side latching formation lies on the same side of the actuating component as the first hook body-side abutment formation.

21. The quick-coupling hook according to claim 20, wherein the hook body-side latching formation is the first hook body-side abutment formation.

22. The quick-coupling hook according to claim 19, wherein the hook body-side latching formation is the first hook body-side abutment formation.

23. The quick-coupling hook according to claim 19, wherein in the setting-up state of the quick-coupling hook a setting-up abutment counter-formation of the actuating component situated at a distance from the actuating component-side latching counter-formation abuts against a hook body-side setting-up abutment formation, where in the setting-up state the distance of the virtual straight connecting line from the hook body-side setting-up abutment formation equals at most double the distance of the virtual straight connecting line from the latching formation.

24. The quick-coupling hook according to claim 21, wherein in the setting-up state of the quick-coupling hook a setting-up abutment counter-formation of the actuating component situated at a distance from the actuating component-side latching counter-formation abuts against a hook body-side setting-up abutment formation, where in the setting-up state the distance of the virtual straight connecting line from the hook body-side setting-up abutment formation equals at most double the distance of the virtual straight connecting line from the latching formation.

25. The quick-coupling hook according to claim 16, wherein in the reference state the first hook body-side abutment formation is situated on the side of the actuating component facing away from the hook mouth and the second hook body-side abutment formation is situated on the side of the actuating component facing towards the hook mouth.

26. The quick-coupling hook according to claim 16, wherein in the reference state and/or in the setting-up state the virtual straight connecting line encloses an angle not exceeding 15°
a) with a mouth center plane which is oriented orthogonally to a cross-sectional area of the accommodating region surrounded by the hook mouth and running centrally both through the opening region and through the accommodating region, and/or
b) with a virtual insertion trajectory of a counter-coupling component to be coupled with the quick-coupling hook into the accommodating region.

27. The quick-coupling hook according to claim 16, wherein the hook body exhibits a connection surface for connecting to a vehicle-side carrier, where in the reference state and/or in the setting-up state the virtual straight connecting line encloses with the connection surface an angle not exceeding 10°.

28. The quick-coupling hook according to claim 19, wherein the actuating component exhibits a sliding surface which runs from a first abutment counter-formation with which in the reference state the actuating component abuts against the first hook body-side abutment formation up to the actuating component-side latching counter-formation.

29. The quick-coupling hook according to claim 16, wherein the securing lock is articulated pivotably about a virtual linkage axis at the actuating component.

30. The quick-coupling hook according to claim 19 wherein the securing lock is articulated pivotably about a virtual linkage axis at the actuating component, wherein in the setting-up state the virtual linkage axis lies on the same side as the hook body-side latching formation and/or the first hook body-side abutment formation with respect to a reference plane containing the virtual straight connecting line and oriented orthogonally to a cross-sectional area of the accommodating region surrounded by the hook mouth.

31. The quick-coupling hook according to claim 16, wherein the force application formation comprises a rear grip formation for a manual finger grip and/or that the force application formation comprises a coupling formation of the actuating component with an output element of an actuator.

32. The quick-coupling hook according to claim 19, wherein in the reference state at least 75% of the actuating component lie on the same side with respect to a reference plane containing the virtual straight connecting line and oriented orthogonally to a cross-sectional area of the accommodating region surrounded by the hook mouth as the hook body-side latching formation and/or the first hook body-side abutment formation.

33. The quick-coupling hook according to claim 16, wherein the quick-coupling hook exhibits an actuator in order to move the actuating component from the operating position into the setting-up position.
